(19) United States
(12) Patent Application Publication
(10) Pub. No.: US 2026/0176452 A1
(43) Pub. Date: Jun. 25, 2026

(54) RUBBER COMPOSITION

(71) Applicant: Compagnie Generale Des Etablissements Michelin, Clermont-Ferrand (FR)

(72) Inventors: François JEAN-BAPTISTE-DIT-DOMINIQUE, Clermont-Ferrand (FR); Robert NGO, Clermont-Ferrand (FR); Marielle RAVIER, Clermont-Ferrand (FR); Kahina MAMMERI, Clermont-Ferrand (FR)

(73) Assignee: Compagnie Generale Des Etablissements Michelin, Clermont-Ferrand (FR)

(21) Appl. No.: 19/123,918

(22) PCT Filed: Oct. 12, 2023
(86) PCT No.: PCT/EP2023/078327

§ 371 Date: Apr. 24, 2025

(30) Foreign Application Priority Data
Oct. 25, 2022 (FR) FR2211083

(51) Int. Cl. C08L 9/00; C08K 5/548; C08L 7/00; C08L 9/06; C08L 23/16

(52) U.S. Cl. CPC C08L 9/00; C08K 5/548; C08L 7/00; C08L 9/06; C08L 23/16

(57) ABSTRACT

A rubber composition that comprises a highly saturated diene elastomer containing 1,3-diene units and more than 50 mol % of ethylene units is provided. The highly saturated diene elastomer bears, at one of its chain ends, a functional group of formula —CH₂—CH(CH₃)—COOZ, Z being a hydrocarbon group substituted by a tertiary amine function. The rubber composition further includes a crosslinking system and a reinforcing filler that comprises a silica or a carbon black. The highly saturated diene elastomer is a copolymer of ethylene and a 1,3-diene or a copolymer of ethylene, a 1,3-diene and an α-monoolefin.

### CROSS REFERENCE TO RELATED APPLICATIONS

This U.S. patent application is a national phase entry of PCT Patent Application No. PCT/EP2023/078327, filed Oct. 12, 2023, which claims priority to French Patent Application No. FR 2211083, filed Oct. 25, 2022, the entire contents of which are incorporated herein by reference in their entirety.

### BACKGROUND

### 1. Technical Field

The field of the invention is that of rubber compositions that are employable especially in the production of tires and that comprise a reinforcing filler and a highly saturated diene elastomer.

### 2. Related Art

As is known, a tire has to meet a large number of often conflicting technical requirements, including low rolling resistance, high wear resistance, and also high dry grip and high wet grip. This trade-off in properties, particularly in terms of rolling resistance and wear resistance, has been able to be improved in recent years in the energy-saving “Green Tires”, intended in particular for passenger vehicles, through the use in particular of novel low-hysteresis rubber compositions having the characteristic of being reinforced predominantly by highly dispersible silicas (HDSs) capable of rivalling conventional tire-grade carbon blacks in terms of reinforcing power.

In document WO 2014114607, the applicant has described the use of highly saturated diene elastomers in rubber compositions for tires in order to modify the performance trade-off between rolling resistance and wear. These highly saturated diene elastomers contain 1,3-diene units and more than 50 mol % of ethylene units.

### SUMMARY

In the course of its work, the applicant has developed a novel low-hysteresis rubber composition that comprises a weakly saturated diene elastomer and a reinforcing filler that contains a silica or a carbon black, also with a view to reducing the rolling resistance of a tire. Indeed, contrary to all expectation, it has developed a low-hysteresis rubber composition that comprises a highly saturated diene elastomer that contains, as a functional group at the chain end of the elastomer, a single methacrylate monomer unit bearing an amine function.

The invention firstly provides a rubber composition that comprises a highly saturated diene elastomer containing 1,3-diene units and more than 50 mol % of ethylene units and bearing at one of its chain ends a functional group of formula —CH₂—CH(CH₃)—COOZ, Z being a hydrocarbon group substituted by a tertiary amine function, a crosslinking system and a reinforcing filler that comprises a silica or a carbon black, the highly saturated diene elastomer being a copolymer of ethylene and a 1,3-diene or a copolymer of ethylene, a 1,3-diene and an α-monoolefin.

The invention secondly provides a tire that includes a tread, said tire comprising a rubber composition in accordance with the invention, preferably in the tread of said tire.

### DETAILED DESCRIPTION

Any interval of values denoted by the expression “between a and b” represents the range of values greater than “a” and less than “b” (that is to say limits a and b excluded), whereas any interval of values denoted by the expression “from a to b” means the range of values extending from “a” up to “b” (that is to say including the strict limits a and b).

The abbreviation “phr” means parts by weight per hundred parts of elastomer (of the total of the elastomers if a plurality of elastomers is present).

In the present disclosure of the invention, the formalism (Cₙ-Cₘ)alkyl is used to denote an alkyl radical having n to m carbon atoms, n being an integer greater than or equal to 1 and m being an integer greater than n. By way of example, (C₁-C₂)alkyl denotes an alkyl radical having 1 to 2 carbon atoms. Similarly, (Cₙ-Cₘ)alkoxy denotes an alkoxy radical having n to m carbon atoms.

The compounds mentioned in the description may be fossil in origin or biobased. In the latter case, they may be partly or completely derived from biomass or obtained from renewable starting materials derived from biomass. Similarly, the compounds mentioned may also originate from the recycling of already-used materials, i.e. they may partly or completely result from a recycling process, or else be obtained from starting materials that themselves result from a recycling process.

In the present invention, a “tire” is understood as meaning a pneumatic or non-pneumatic tire. A pneumatic tire usually includes two beads intended to come into contact with a rim, a crown composed of at least one crown reinforcement and a tread, two sidewalls, the tire being reinforced by a carcass reinforcement anchored in the two beads. A non-pneumatic tire, on the other hand, usually comprises a base, designed for example for mounting on a rigid rim, a crown reinforcement ensuring the connection with a tread, and a deformable structure, such as spokes, ribs or cells, this structure being arranged between the base and the crown. Such non-pneumatic tires do not necessarily comprise a sidewall. Non-pneumatic tires are described for example in documents WO 03/018332 and FR2898077. According to any one of the embodiments of the invention, the tire according to the invention is preferably a pneumatic tire.

The expression “based on” used to define the constituents of a catalyst system (or catalyst composition) is understood as meaning the mixture of these constituents, or the product of the reaction of some or all of these constituents with one another.

The elastomer employable for the purposes of the invention is a highly saturated diene elastomer, given that the ethylene units represent more than 50 mol % of all of the monomer units in the highly saturated diene elastomer. Preferably, the highly saturated diene elastomer is a statistical copolymer.

As is known, the expression “ethylene unit” refers to the —(CH₂—CH₂)— unit resulting from the insertion of ethylene into the elastomer chain. The ethylene units in the highly saturated diene elastomer preferably represent at least 60 mol % of all of the monomer units in the highly saturated diene elastomer, more preferably at least 65 mol % of all of the monomer units in the highly saturated diene elastomer. Even more preferably, the ethylene units in the highly saturated diene elastomer represent at least 70 mol % of all of the monomer units in the highly saturated diene elastomer.

Preferably, the ethylene units in the highly saturated diene elastomer represent less than 90 mol % of all of the monomer units in the highly saturated diene elastomer. More preferably, the ethylene units represent at most 85 mol % of all of the monomer units in the highly saturated diene elastomer. Even more preferably, the ethylene units represent at most 80 mol % of all of the monomer units in the highly saturated diene elastomer.

According to one advantageous embodiment, the highly saturated diene elastomer comprises from 60 mol % to less than 90 mol % of ethylene units, particularly from 60 mol % to 85 mol % of ethylene units, the molar percentage being calculated on the basis of all of the monomer units in the highly saturated diene elastomer. More advantageously, the highly saturated diene elastomer comprises from 60 mol % to 80 mol % of ethylene units, the molar percentage being calculated on the basis of all of the monomer units in the highly saturated diene elastomer.

According to another advantageous embodiment, the highly saturated diene elastomer comprises from 65 mol % to less than 90 mol % of ethylene units, particularly from 65 mol % to 85 mol % of ethylene units, the molar percentage being calculated on the basis of all of the monomer units in the highly saturated diene elastomer. More advantageously, the highly saturated diene elastomer comprises from 65 mol % to 80 mol % of ethylene units, the molar percentage being calculated on the basis of all of the monomer units in the highly saturated diene elastomer.

According to yet another advantageous embodiment of the invention, the highly saturated diene elastomer comprises from 70 mol % to less than 90 mol % of ethylene units, particularly from 70 mol % to 85 mol % of ethylene units, the molar percentage being calculated on the basis of all of the monomer units in the highly saturated diene elastomer. More advantageously, the highly saturated diene elastomer comprises from 70 mol % to 80 mol % of ethylene units, the molar percentage being calculated on the basis of all of the monomer units in the highly saturated diene elastomer.

The highly saturated diene elastomer also comprises 1,3-diene units resulting from the polymerization of a 1,3-diene. As is known, the expression “1,3-diene unit” or “diene unit” refers to units resulting from the insertion of the 1,3-diene via a 1,4-addition, a 1,2-addition or a 3,4-addition in the case of isoprene, for example.

According to one embodiment of the invention, the 1,3-diene units represent at least 35 mol % of the monomer units in the highly saturated diene elastomer.

According to one embodiment of the invention, the 1,3-diene units represent less than 35 mol % of the monomer units in the highly saturated diene elastomer.

The highly saturated diene elastomer may contain α-monoolefin units. An α-monoolefin is understood as meaning an α-olefin that contains at least 3 carbon atoms and that has a single carbon-carbon double bond, not including the double bonds in aromatic compounds. For example, styrene is regarded as α-monoolefin. The α-monoolefin is preferably aromatic, more preferably styrene or a styrene in which the benzene ring is substituted by one or more alkyl groups. Even more preferably, the α-monoolefin is styrene.

The 1,3-diene is a single compound, that is to say just a single (one) 1,3-diene, or a mixture of 1,3-dienes that differ from one another in their chemical structure. For example, 1,3-dienes having 4 to 20 carbon atoms are suitable as the 1,3-diene. Preferably, the 1,3-diene is 1,3-butadiene, isoprene, myrcene, β-farnesene or mixtures thereof, such as a mixture of at least two of them. The mixture of at least two of them is advantageously a mixture that contains 1,3-butadiene. The mixture of 1,3-dienes is preferably a mixture of 1,3-butadiene and myrcene or a mixture of 1,3-butadiene and β-farnesene.

According to a particularly preferred embodiment of the invention, the 1,3-diene is a mixture of 1,3-butadiene and myrcene or a mixture of 1,3-butadiene and β-farnesene.

According to another particularly preferred embodiment of the invention, the 1,3-diene is 1,3-butadiene.

The highly saturated diene elastomer is advantageously a copolymer of ethylene and a 1,3-diene, in which case the units making up the highly saturated diene elastomer are those resulting from the polymerization of a 1,3-diene and ethylene. In particular, the highly saturated diene elastomer is a copolymer of ethylene and 1,3-butadiene or a copolymer of ethylene, 1,3-butadiene and myrcene or else a copolymer of ethylene, 1,3-butadiene and β-farnesene. The highly saturated diene elastomer is more advantageously a statistical copolymer of ethylene and 1,3-butadiene or a statistical copolymer of ethylene, 1,3-butadiene and myrcene or else a statistical copolymer of ethylene, 1,3-butadiene and β-farnesene.

According to a particularly preferred embodiment of the invention, especially when the 1,3-diene is 1,3-butadiene or a mixture of 1,3-dienes, one of which is 1,3-butadiene, the highly saturated diene elastomer contains 1,2-cyclohexane units, cyclic units of formula (I).

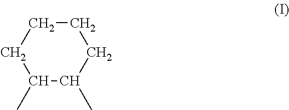

The presence of a saturated 6-membered 1,2-cyclohexane ring unit of formula (I) in the highly saturated diene elastomer may result from a series of very specific insertions of ethylene and of 1,3-butadiene into the polymer chain during its growth. The mechanism for obtaining such a microstructure is described for example in Macromolecules 2009, 42, 3774-3779. When the highly saturated diene elastomer comprises units of formula (I), it preferably contains at most 15 mol % thereof, the percentage being expressed relative to all of the monomer units.

Another feature of the highly saturated diene elastomer is that it bears at one of its chain ends a functional group of formula —CH₂—CH(CH₃)—COOZ. The functional group is typically attached covalently to the end of the highly saturated diene elastomer chain, one of the carbon atoms of the methylene (CH₂) of the functional group being covalently bonded to one of the carbon atoms making up the terminal monomer unit of the highly saturated diene elastomer.

The symbol Z denotes a hydrocarbon group substituted by a tertiary amine function. Preferably, Z denotes a saturated acyclic hydrocarbon group substituted by a tertiary amine function, the saturated acyclic hydrocarbon group substituted by a tertiary amine function advantageously being an alkyl having 1 to 3 carbon atoms. The tertiary amine function is preferably an N,N-dialkylamino group, the alkyl groups substituting the nitrogen atom preferably each having 1 to 3 carbon atoms, better still 1 carbon atom or 2 carbon atoms. The alkyl groups substituting the nitrogen atom are preferably identical according to any one of the embodiments of the invention.

According to a most particularly preferred embodiment, Z denotes an N,N-di(C₁-C₃)alkylamino(C₁-C₃)alkyl group, preferably 2-(N,N-dimethylamino)ethyl, 2-(N,N-diethylamino)ethyl or 2-(N,N-diisopropylamino)ethyl, more preferably 2-(N,N-dimethylamino)ethyl.

The functional highly saturated diene elastomer employable for the purposes of the invention can be prepared by a process that comprises the successive steps a), b) and c),
step a) being the polymerization of a monomer mixture containing the 1,3-diene and ethylene and, where appropriate, the α-monoolefin in the presence of a catalyst system based at least on a metallocene of formula (Ia) and an organomagnesium compound

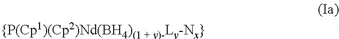

Cp¹ and Cp², which are identical or different, being selected from the group consisting of fluorenyl groups, cyclopentadienyl groups and indenyl groups, the groups being substituted or unsubstituted,
P being a group bridging the two groups Cp¹ and Cp² and comprising a silicon or carbon atom,
Nd denoting the neodymium atom,
L representing an alkali metal selected from the group consisting of lithium, sodium and potassium,
N representing a molecule of an ether,
x being an integer or non-integer equal to or greater than 0,
y being an integer equal to or greater than 0,
the olefin being ethylene or a mixture of ethylene and an α-monoolefin,
step b) being the reaction of a methacrylate with the reaction product of the polymerization in step a),
step c) being a chain termination reaction.

Step a) of the process is a polymerization reaction of a monomer mixture containing the 1,3-diene and ethylene and, where appropriate, the α-monoolefin, which enables the preparation of the chains of the highly saturated diene elastomer: growing chains intended to undergo reaction in the next step, step b), with a functionalization agent, a methacrylate.

Preferably, the monomer mixture in step a) contains more than 50 mol % of ethylene, the percentage being expressed relative to the total number of moles of monomer in the monomer mixture in step a). When the monomer mixture contains an α-monoolefin, such as styrene, it preferably contains less than 40 mol % of the α-monoolefin, the percentage being expressed relative to the total number of moles of monomers in the monomer mixture in step a). Preferably, the monomer mixture in step a) is a mixture of a 1,3-diene and ethylene.

The copolymerization of the monomer mixture can be carried out in accordance with patent applications WO 2007054223 A2 and WO 2007054224 A2 using a catalyst system composed of a metallocene and an organomagnesium compound.

In the present patent application, a “metallocene” is understood as meaning an organometallic complex in which the metal, in this case the neodymium atom, is bonded to a molecule termed a ligand and consisting of two groups Cp¹ and Cp² connected together by a bridge P. These groups Cp¹ and Cp², which are identical or different, are selected from the group consisting of fluorenyl groups, cyclopentadienyl groups and indenyl groups, it being possible for these groups to be substituted or unsubstituted.

According to the invention, the metallocene used as base constituent in the catalyst system corresponds to the formula (Ia)

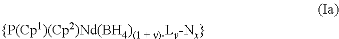

P being a group bridging the two groups Cp¹ and Cp² and comprising a silicon or carbon atom,
Cp¹ and Cp², which are identical or different, being selected from the group consisting of fluorenyl groups, cyclopentadienyl groups and indenyl groups, the groups being substituted or unsubstituted,
Nd denoting the neodymium atom,
L representing an alkali metal selected from the group consisting of lithium, sodium and potassium,
N representing a molecule of an ether,
x being an integer or non-integer equal to or greater than 0,
y being an integer equal to or greater than 0.

Any ether that has the ability to complex the alkali metal, especially diethyl ether, methyltetrahydrofuran and tetrahydrofuran, is suitable as the ether.

Substituted cyclopentadienyl, fluorenyl and indenyl groups include those substituted by alkyl radicals having from 1 to 6 carbon atoms or by aryl radicals having from 6 to 12 carbon atoms or else by trialkylsilyl radicals, such as SiMe₃. The choice of radicals is guided also by the obtainability of the parent molecules, these being the substituted cyclopentadienes, fluorenes and indenes, since said molecules are commercially available or can be readily synthesized.

Substituted fluorenyl groups include those substituted in the 2, 7, 3 or 6 position, particularly 2,7-di(tert-butyl) fluorenyl and 3,6-di(tert-butyl) fluorenyl. The 2, 3, 6 and 7 positions respectively denote the positions of the carbon atoms in the rings as shown in the diagram below, the 9 position corresponding to the carbon atom to which the bridge P is attached.

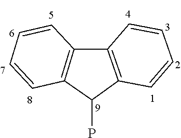

Substituted cyclopentadienyl groups include those substituted either in the 2 (or 5) position or in the 3 (or 4) position, particularly those substituted in the 2 position, more particularly the tetramethylcyclopentadienyl group. The 2 (or 5) position denotes the position of the carbon atom adjacent to the carbon atom to which the bridge P is attached, as shown in the diagram below. It should be noted that substitution in the 2 or 5 position is also referred to as substitution in the α position to the bridge.

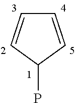

Substituted indenyl groups include in particular those substituted in the 2 position, more particularly 2-methylindenyl or 2-phenylindenyl. The 2 position denotes the position of the carbon atom adjacent to the carbon atom to which the bridge P is attached, as shown in the diagram below.

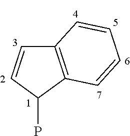

Preferably, Cp¹ and Cp², which are identical or different, are cyclopentadienyls substituted in the α position to the bridge, substituted fluorenyls, substituted indenyls or fluorenyls of formula C₁₃H₈ or indenyls of formula C₉H₇. More preferably, Cp¹ and Cp², which are identical or different, are selected from the group consisting of substituted fluorenyl groups and the unsubstituted fluorenyl group of formula C₁₃H₈. It is advantageous when Cp¹ and Cp² are identical and each represent an unsubstituted fluorenyl group of formula C₁₃H₈, represented by the symbol Flu.

Preferably, the bridge P connecting the groups Cp¹ and Cp² is of formula ZR₁R₂, in which Z represents a silicon or carbon atom and R₁ and R₂, which are identical or different, each represent an alkyl group comprising from 1 to 20 carbon atoms, preferably a methyl. In the formula ZR₁R₂, Z advantageously represents an atom of silicon, Si.

Better still, the metallocene is of formula (I-1), (I-2), (I-3), (I-4) or (I-5):

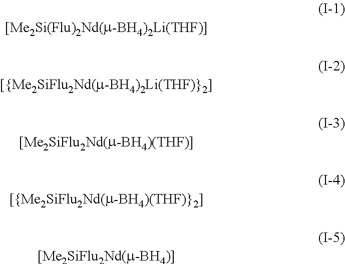

in which Flu represents the group C₁₃H₈.

The metallocene employable for the synthesis of the catalyst system may be in the form of a crystalline or non-crystalline powder, or else in the form of single crystals. The metallocene may be in monomeric or dimeric form, these forms depending on the method of preparation of the metallocene, such as for example that described in patent application WO 2007054224 A2 or WO 2007054223 A2. The metallocene may be conventionally prepared by a method analogous to that described in patent application WO 2007054224 A2 or WO 2007054223 A2, especially by reaction under inert and anhydrous conditions of an alkali metal salt of the ligand with a borohydride of the rare earth metal neodymium in a suitable solvent such as an ether, such as diethyl ether or tetrahydrofuran, or any other solvent known to those skilled in the art. After reaction, the metallocene is separated from the reaction by-products via techniques known to those skilled in the art, such as filtration or precipitation from a second solvent. The metallocene is finally dried and isolated in solid form.

The organomagnesium compound, another base constituent of the catalyst system, is the co-catalyst of the catalyst system. Typically, the organomagnesium compound may be a diorganomagnesium reagent or an organomagnesium halide. Preferably, the organomagnesium compound is of formula (IIa) or (IIb), in which R³ and R⁴, which are identical or different, represent a carbon-based group and X is a halogen atom.

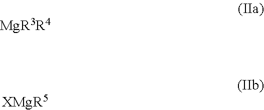

A “carbon-based group” is understood as meaning a group that contains one or more carbon atoms. The carbon-based group may be a hydrocarbon group (hydrocarbyl group) or a heterohydrocarbon group, that is to say a group including one or more heteroatoms in addition to carbon and hydrogen atoms. Suitable organomagnesium compounds having a heterohydrocarbon group include the compounds described as transfer agents in patent application WO 2016/092227 A1. The carbon-based groups represented by the symbols R³ and R⁴ are preferably hydrocarbon groups.

The carbon-based groups represented by R³ and R⁴ may be aliphatic or aromatic. They may contain one or more heteroatoms such as an oxygen, nitrogen, silicon or sulfur atom. Preferably, they are alkyl, phenyl or aryl. They may contain from 1 to 20 carbon atoms.

The alkyls represented as R³ and R⁴ may contain 2 to 10 carbon atoms and are especially ethyl, butyl or octyl.

The aryls represented as R³ and R⁴ may contain 7 to 20 carbon atoms and are especially phenyl substituted by one or more alkyls such as methyl, ethyl or isopropyl.

R³ and R⁴ are preferably alkyls containing from 2 to 10 carbon atoms, phenyls or aryls containing from 7 to 20 carbon atoms.

According to a particular embodiment of the invention, R³ comprises a benzene ring in which two carbon atoms are substituted: one of the two is substituted by a methyl, an ethyl or an isopropyl or forms a ring with the carbon atom closest to it, the second carbon atom being substituted by a methyl, an ethyl or an isopropyl, the magnesium atom being in the ortho position to each of said two carbon atoms and R⁴ is an alkyl. According to this specific embodiment, R³ is advantageously 1,3-dimethylphenyl, 1,3-diethylphenyl, mesityl, or 1,3,5-triethylphenyl and R⁴ is advantageously ethyl, butyl or octyl.

According to another specific embodiment of the invention, R³ and R⁴ are alkyls containing 2 to 10 carbon atoms, especially ethyl, butyl or octyl.

Examples of suitable organomagnesium compounds are butylethylmagnesium, butyloctylmagnesium, ethylmagnesium chloride, butylmagnesium chloride, ethylmagnesium bromide, butylmagnesium bromide, octylmagnesium chloride, octylmagnesium bromide, 1,3-dimethylphenylbutylmagnesium, 1,3-diethylphenylethylmagnesium, butylmesitylmagnesium, ethylmesitylmagnesium, 1,3-diethylphenylbutylmagnesium, 1,3-diethylphenylethylmagnesium, 1,3-diisopropylphenylbutylmagnesium, 1,3-diisopropylphenylethylmagnesium, 1,3,5-triethylphenylbutylmagnesium, 1,3,5-triethylphenylethylmagnesium, 1,3,5-triisopropylphenylbutylmagnesium and 1,3,5-triisopropylphenylethylmagnesium.

The compounds of formula (IIa) and (IIb), which are Grignard reagents, are well known and some of them are even commercial products. For their synthesis, reference may also be made, for example, to the collection of volumes of “Organic Synthesis”.

Like any organomagnesium compound, the organomagnesium compound constituting the catalyst system, especially of formula (IIa) or (IIb), may be in the form of a monomeric species or in the form of a polymeric species. By way of illustration, the organomagnesium compound (Ila) may be in the form of a monomeric species (MgR³R⁴)₁ or in the form of a polymeric species (MgR³R⁴)ₚ, p being an integer greater than 1, especially dimeric (MgR³R⁴)₂.

Moreover, whether it be in the form of a monomeric or polymeric species, the organomagnesium compound may also be in the form of a species coordinated to one or more molecules of a solvent, preferably of an ether such as diethyl ether, tetrahydrofuran or methyltetrahydrofuran.

According to any one of the embodiments of the invention, the organomagnesium compound is preferably of formula (IIa).

The amounts of co-catalyst and metallocene reacted are such that the ratio between the number of moles of Mg in the co-catalyst and the number of moles of rare earth metal in the metallocene, neodymium, is preferably from 0.5 to 200, more preferably from 1 to less than 20. The range of values extending from 1 to less than 20 is particularly favourable for obtaining copolymers of high molar mass.

According to one embodiment, the catalyst system is conventionally prepared by a method analogous to that described in patent application WO 2007054224 A2 or WO 2007054223 A2. For example, the cocatalyst, in this case the organomagnesium compound, and the metallocene are reacted in a hydrocarbon solvent typically at a temperature ranging from 20° C. to 80° C. for a period of between 5 and 60 minutes. The catalyst system is generally prepared in an aliphatic hydrocarbon solvent, such as methylcyclohexane, or an aromatic hydrocarbon solvent, such as toluene, preferably in an aliphatic hydrocarbon solvent, such as methylcyclohexane. After its synthesis, the catalyst system is generally used as is in step a).

According to another embodiment, the catalyst system is prepared by a method analogous to that described in patent application WO 2017093654 A1 or in patent application WO 2018020122 A1: it is said to be of preformed type. For example, the organomagnesium compound and the metallocene are reacted in a hydrocarbon solvent typically at a temperature of from 20° C. to 80° C. for 10 to 20 minutes to obtain a first reaction product, and a preformation monomer is then reacted with this first reaction product at a temperature ranging from 40° C. to 90° C. for 1 hour to 12 hours. The preformation monomer is preferably used in a molar ratio (preformation monomer/metallocene metal) ranging from 5 to 1000, preferably from 10 to 500. Prior to its use in polymerization, the preformed catalyst system can be stored under an inert atmosphere, especially at a temperature ranging from −20° C. to room temperature (23° C.). The preformed catalyst system has as its base constituent a preformation monomer selected from 1,3-dienes, ethylene and mixtures thereof. In other words, the “preformed” catalyst system contains a preformation monomer in addition to the metallocene and the co-catalyst. The 1,3-diene serving as preformation monomer may be 1,3-butadiene, isoprene or else a 1,3-diene of formula CH₂═CR⁶—CH═CH₂, the symbol R⁶ representing a hydrocarbon group having 3 to 20 carbon atoms, in particular myrcene or β-farnesene. The preformation monomer is preferably 1,3-butadiene.

The catalyst system is typically present in a solvent that is preferably the solvent in which it was prepared, and the concentration of rare earth metal, i.e. neodymium, in the metallocene is then within a range preferably from 0.0001 to 0.2 mol/L, more preferably from 0.001 to 0.03 mol/L.

Like any synthesis performed in the presence of an organometallic compound, the synthesis of the metallocene, the synthesis of the organomagnesium compound and the synthesis of the catalyst system take place in anhydrous conditions under an inert atmosphere. Typically, the reactions are performed starting with anhydrous solvents and compounds under anhydrous nitrogen or argon.

The polymerization of the monomer mixture is preferably carried out in solution, either continuously or discontinuously. The polymerization solvent is typically a hydrocarbon solvent, preferably an aliphatic hydrocarbon solvent. A particularly suitable example of an aliphatic hydrocarbon solvent is methylcyclohexane. The monomer mixture may be introduced into the reactor containing the polymerization solvent and the catalyst system or, conversely, the catalyst system may be introduced into the reactor containing the polymerization solvent and the monomer mixture. The monomer mixture and the catalyst system may be introduced into the reactor containing the polymerization solvent simultaneously, especially in the case of a continuous polymerization. The polymerization is typically carried out under anhydrous conditions and in the absence of oxygen, in the optional presence of an inert gas. The polymerization temperature generally ranges from 40° C. to 150° C., preferably 40° C. to 120° C. A person skilled in the art adapts the polymerization conditions, such as the polymerization temperature, the concentration of each of the reagents and the pressure in the reactor, in line with the composition of the monomer mixture, the polymerization reactor and the desired microstructure and macrostructure of the copolymer chain.

The polymerization is preferably carried out at a constant monomer pressure. One or each of the monomers may be added continuously to the polymerization reactor, in which case the polymerization reactor is a fed reactor. This embodiment is most particularly suitable for a statistical incorporation of the monomers. Preferably, the polymerization in step a) is a statistical polymerization, which is reflected in statistical incorporation of the monomers of the monomer mixture used in step a).

Once the desired degree of monomer conversion has been achieved in the polymerization reaction in step a), step b) is carried out.

Step b) of the process according to the invention brings together a functionalization agent, a methacrylate, with the reaction product from step a) in order to introduce the functional group employable for the purposes of the invention, a methacrylate monomer unit, at one of the ends of the highly saturated diene elastomer chain produced on conclusion of step a). Step b) is a functionalization reaction at the end of the highly saturated diene elastomer chain without there being subsequent polymerization of the methacrylate.

The methacrylate is a “functional” methacrylate and is of formula CH₂═CCH₃COOR′, R′ being a hydrocarbon group substituted by a tertiary amine function.

The hydrocarbon group of symbol R′ is preferably saturated. The number of carbon atoms in the hydrocarbon group of symbol R′ is not limited per se. The hydrocarbon group may contain up to 20 carbon atoms. Preferably, the hydrocarbon group of symbol R′ contains from 1 to 6 carbon atoms, more preferably from 1 to 3 carbon atoms. Preferably, the hydrocarbon group of symbol R′ is a saturated acyclic hydrocarbon group substituted by said tertiary amine function.

Preferably, the methacrylate is of formula CH₂═CCH₃COOR′ in which R′ is an alkyl, saturated acyclic hydrocarbon group, that is substituted by a dialkylamino group, in particular the methacrylate is an N,N-di(C₁-C₃)alkylamino(C₁-C₃)alkyl methacrylate, preferably 2-(dimethylamino)ethyl methacrylate, 2-(diethylamino)ethyl methacrylate, 2-(diisopropylamino)ethyl methacrylate, more preferably 2-(dimethylamino)ethyl methacrylate.

The methacrylates employable for the purposes of the invention can be commercial products. These are generally commercially available products. When the methacrylates are packaged in the presence of a stabilizer, as is the case for most commercial methacrylates, they are typically used after removal of the stabilizer, which can be carried out in a well-known manner by distillation or by treatment on alumina columns.

Preferably, step b) is carried out in an aliphatic hydrocarbon solvent, such as methylcyclohexane. It is advantageously carried out in the reaction medium resulting from step a). It is generally carried out by adding the methacrylate to the reaction product from step a) in its reaction medium with stirring.

Before the addition of the methacrylate, the reactor is preferably degassed and inertized. The degassing of the reactor removes gaseous residual monomers and also facilitates the addition of the methacrylate to the reactor. Inertizing the reactor, for example with nitrogen, helps to prevent the carbon-metal bonds present in the reaction medium and necessary for the copolymer functionalization reaction from being deactivated. The methacrylate can be added neat or diluted in a hydrocarbon solvent, preferably an aliphatic hydrocarbon solvent such as methylcyclohexane. The methacrylate is left in contact with the reaction product from step a) for the time necessary for the functionalization reaction of the copolymer chain end. The functionalization reaction can typically be monitored by chromatographic analysis in order to monitor consumption of the methacrylate. The functionalization reaction is preferably carried out at a temperature ranging from 23° C. to 120° C., for 1 to 60 minutes, with stirring. The functionalization reaction is preferably carried out with a molar excess of methacrylate relative to the number of moles of neodymium and of magnesium. In order to achieve virtually quantitative functionalization, the molar ratio of the number of moles of methacrylate to the number of moles of neodymium and of magnesium is greater than 2, in particular greater than 4. The molar ratio between the number of moles of the methacrylate and the number of moles of neodymium and of magnesium preferably ranges from 4 to 50, more preferably from 4 to 10.

Once the chain end has been modified, step b) is followed by step c).

Step c), the chain termination reaction, is typically a reaction that makes it possible to deactivate the reactive sites still present in the reaction medium resulting from step b). In step c), a chain-terminating agent is contacted with the reaction product from step b), generally in its reaction medium, for example by adding the terminating agent to the reaction medium resulting from step b) or by pouring the reaction medium obtained on conclusion of step b) onto a solution containing the terminating agent. The terminating agent is generally added in excess with respect to the number of carbon-metal bonds such as C—Mg and C—Nd present in the reaction medium. The terminating agent is typically a protic compound, a compound that contains a relatively acidic proton. Terminating agents include water, carboxylic acids, especially C₂-C₁₈ fatty acids, such as acetic acid or stearic acid, aliphatic or aromatic alcohols, such as methanol, ethanol or isopropanol, or phenolic antioxidants.

After reaction with a protic compound, the process results in the highly saturated diene elastomer bearing a tertiary amine function at one of its chain ends.

The highly saturated diene elastomer bearing a tertiary amine function at one of its chain ends can be separated from the reaction medium from step c) by methods well known to those skilled in the art, for example by an evaporation of solvent under reduced pressure operation or by a steam stripping operation.

Preferably, the rubber composition contains more than 50 phr of the highly saturated diene elastomer employable for the purposes of the invention, more preferably at least 80 phr of the highly saturated diene elastomer employable for the purposes of the invention. The balance to 100 phr may consist wholly or partly of a diene and ethylene elastomer in which the functional group employable for the purposes of the invention of formula —CH₂—CH(CH₃)—COOZ, as described in the present patent application, is absent. The rubber composition may also comprise an elastomer selected from the group of diene elastomers consisting of polybutadienes, polyisoprenes, butadiene copolymers, isoprene copolymers and mixtures thereof. The content of the highly saturated diene elastomer employable for the purposes of the invention is advantageously 100 phr. The highly saturated diene elastomer employable for the purposes of the invention may consist of a mixture of highly saturated diene elastomers employable for the purposes of the invention that differ from one another in their microstructures or in their macrostructures.

The rubber composition also has the essential feature of containing a reinforcing filler that comprises a silica or a carbon black.

The silica used may be any reinforcing silica known to those skilled in the art, especially any precipitated or fumed silica having a BET specific surface area and also a CTAB specific surface area of in both cases less than 450 m²/g, preferably from 30 to 400 m²/g, especially between 60 and 300 m²/g. Examples of highly dispersible precipitated silicas (“HDSs”) include the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber or the silicas with a high specific surface area such as are described in application WO 03/016387.

In the present disclosure, the BET specific surface area is determined in a known manner by gas adsorption using the Brunauer-Emmett-Teller method described in “The Journal of the American Chemical Society”, vol. 60, page 309, February 1938, more specifically in accordance with French standard NF ISO 9277 of December 1996 (multipoint volumetric method (5 points)-gas: nitrogen—degassing: 1 hour at 160° C.—relative pressure p/po range: 0.05 to 0.17). The CTAB specific surface area is the external surface area determined in accordance with French standard NF T 45-007 of November 1987 (method B).

The physical state in which the silica is provided is not important, whether it be in the form of a powder, microbeads, granules or beads. Silica is of course also understood as meaning mixtures of different reinforcing silicas, in particular of highly dispersible silicas as described above.

Those skilled in the art will understand that, as filler equivalent to the silica described in the present section, it is possible to use a reinforcing filler of another nature, especially an organic nature, such as carbon black, provided this reinforcing filler is covered with a layer of silica, or else includes, at its surface, functional sites, especially hydroxyl sites, requiring the use of a coupling agent in order to establish the bond between the filler and the elastomer. Examples include carbon blacks for tires, such as are described for example in patent documents WO 96/37547 and WO 99/28380.

All carbon blacks, especially blacks of the HAF, ISAF, SAF, FF, FEF, GPF and SRF type, conventionally used in rubber compositions for tires (“tire-grade” blacks) are suitable as carbon blacks. These carbon blacks can be used in isolation, as available commercially, or in any other form, for example as support for some of the rubber additives used.

According to one embodiment of the invention, the reinforcing filler comprises a mixture of silica and carbon black. When the rubber composition contains a mixture of silica and carbon black, the carbon black is preferably used in a content of less than 20 phr, more preferably of less than 10 phr (for example, between 0.5 and 20 phr, especially between 2 and 10 phr). Within the intervals stated, benefit is obtained from the colouring properties (black pigmenting agent) and UV-stabilizing properties of the carbon blacks, without this adversely affecting the typical performance qualities contributed by the silica.

According to a most particularly preferred embodiment of the invention, the reinforcing filler contains more than 50% by mass of silica. More preferably, the reinforcing filler contains more than 50% by mass of silica and contains carbon black in a content of less than or equal to 5 phr.

In order to couple the silica to the elastomer, use is made, in a well-known manner, of an at least bifunctional coupling agent, especially a silane, (or bonding agent) intended to ensure a satisfactory connection between the silica (surface of its particles) and the elastomer. Use is made in particular of organosilanes or polyorganosiloxanes that are at least bifunctional.

Use is made especially of silane polysulfides, referred to as “symmetrical” or “asymmetrical” depending on their specific structure, such as are described for example in applications WO03/002648 (or US 2005/016651) and WO03/002649 (or US 2005/016650).

Particularly suitable, without the definition below being limiting, are silane polysulfides corresponding to the general formula (III)

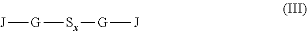

in which
x is an integer from 2 to 8 (preferably from 2 to 5);
the symbols G, which are identical or different, represent a divalent hydrocarbon radical (preferably a C₁-C₁₈ alkylene group or a C₆-C₁₂ arylene group, more particularly a C₁-C₁₀ alkylene, especially a C₁-C₄ alkylene, in particular propylene);
the symbols J, which are identical or different, correspond to one of the three formulas below:

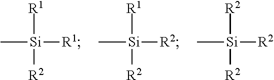

in which:
the radicals R¹, substituted or unsubstituted, identical or different from one another, represent a C₁-C₁₈ alkyl group, a C₅-C₁₈ cycloalkyl group or C₆-C₁₈ aryl group (preferably a C₁-C₆ alkyl group, a cyclohexyl group or a phenyl group, especially C₁-C₄ alkyl groups, more particularly methyl and/or ethyl)
the radicals R², substituted or unsubstituted, identical or different from one another, represent a C₁-C₁₈ alkoxy group or a C₅-C₁₈ cycloalkoxy group (preferably a group selected from C₁-C₈ alkoxy or C₅-C₈ cycloalkoxy, even more preferably a group selected from C₁-C₄ alkoxy, in particular methoxy and/or ethoxy).

In the case of a mixture of alkoxysilane polysulfides corresponding to the above formula (I), especially customary commercially available mixtures, the average value of “x” is a fractional number preferably of between 2 and 5, more preferably close to 4. However, the invention can also be advantageously implemented for example with alkoxysilane disulfides (x=2).

Examples of silane polysulfides include more particularly bis((C₁-C₄)alkoxy (C₁-C₄)alkylsilyl(C₁-C₄)alkyl) polysulfides (especially disulfides, trisulfides or tetrasulfides), such as for example bis(3-trimethoxysilylpropyl) or bis(3-triethoxysilylpropyl) polysulfides. Among these compounds, use is made in particular of bis(3-triethoxysilylpropyl) tetrasulfide, abbreviated to TESPT, of formula [(C₂H₅O)₃Si(CH₂)₃S₂]₂, or bis(triethoxysilylpropyl) disulfide, abbreviated to TESPD, of formula [(C₂H₅O)₃Si(CH₂)₃S]₂.

Coupling agents other than alkoxysilane polysulfides include in particular bifunctional POSs (polyorganosiloxanes), or else hydroxysilane polysulfides, such as are described in patent applications WO 02/30939 (or U.S. Pat. No. 6,774,255) and WO 02/31041 (or US 2004/051210), or else silanes or POSs bearing azodicarbonyl functional groups, such as are described for example in patent applications WO 2006/125532, WO 2006/125533 and WO 2006/125534.

The content of coupling agent is advantageously less than 30 phr, it being understood that it is generally desirable to use as little as possible thereof. Typically, the content of coupling agent represents from 0.5% to 15% by weight relative to the amount of silica. Its content is preferably between 0.5 and 16 phr, more preferably within a range extending from 3 to 10 phr. This content is easily adjusted by those skilled in the art according to the content of silica used in the composition.

Preferably, the total content of reinforcing filler, whether silica or carbon black or else a mixture thereof, is between 30 and 200 phr, more preferably between 40 and 160 phr. Either of these ranges for the total content of reinforcing filler can apply to any of the embodiments of the invention.

In addition to coupling agents, the rubber composition according to the invention may also contain coupling activators, agents for covering the inorganic fillers or, more generally, processing aids that are capable, in a known manner, of improving processability in the uncured state by improving the dispersion of the filler in the rubber matrix and lowering the viscosity of the compositions.

The rubber composition has another essential feature of containing a crosslinking system. Chemical crosslinking permits the formation of covalent bonds between the elastomer chains. The crosslinking system may be a vulcanization system or one or more peroxide compounds. According to any of the embodiments of the invention, the crosslinking system is preferably a vulcanization system.

The vulcanization system itself is based on sulfur (or on a sulfur donor) and on a primary vulcanization accelerator. In addition to this base vulcanization system, various known secondary vulcanization accelerators or vulcanization activators, such as zinc oxide, stearic acid or equivalent compounds, or guanidine derivatives (in particular diphenylguanidine) are incorporated during the first, non-productive phase and/or during the productive phase, as described subsequently. The sulfur is used in a content preferably of 0.5 to 12 phr, in particular of 1 to 10 phr. The primary vulcanization accelerator is used in a content preferably of between 0.5 and 10 phr, more preferably of between 0.5 and 5 phr. The accelerator (primary or secondary) used may be any compound capable of acting as accelerator of the vulcanization of diene elastomers in the presence of sulfur, especially accelerators of the thiazole type and derivatives thereof, or accelerators of thiuram or zinc dithiocarbamate type. Preference is given to using a primary accelerator of the sulfenamide type.

When the chemical crosslinking is carried out using one or more peroxide compounds, said peroxide compound(s) preferably represent from 0.01 to 10 phr. Peroxide compounds employable as chemical crosslinking system include acyl peroxides, for example benzoyl peroxide or p-chlorobenzoyl peroxide, ketone peroxides, for example methyl ethyl ketone peroxide, peroxyesters, for example t-butyl peroxyacetate, t-butyl peroxybenzoate and t-butyl peroxyphthalate, alkyl peroxides, for example dicumyl peroxide, di(t-butyl) peroxybenzoate and 1,3-bis(t-butylperoxyisopropyl)benzene, or hydroperoxides, for example t-butyl hydroperoxide.

The rubber composition according to the invention may also comprise some or all of the usual additives customarily used in elastomer compositions intended to constitute external mixtures of finished rubber articles, such as tires, in particular treads, such as for example plasticizers or extender oils, whether these be aromatic or non-aromatic in nature, especially hydrocarbon plasticizing resins of very weakly aromatic or non-aromatic oils (for example paraffinic or hydrogenated naphthenic oils, MES oils or TDAE oils), vegetable oils, in particular glycerol esters, such as glyceryl trioleates, pigments, protective agents such as anti-ozone waxes, chemical antiozonants or antioxidants.

The rubber composition according to the invention can be produced in appropriate mixers by employing two successive preparation phases according to a general procedure well known to those skilled in the art: a first phase of thermomechanical working or kneading (sometimes referred to as “non-productive” phase) at high temperature, up to a maximum temperature of between 130° C. and 200° C., preferably between 145° C. and 185° C., followed by a second phase of mechanical working (sometimes referred to as “productive” phase) at lower temperature, typically below 120° C., for example between 60° C. and 100° C.; during this finishing phase the chemical crosslinking agent, in particular the vulcanization system, is incorporated.

Generally, all the base constituents of the composition included in the tire of the invention, with the exception of the crosslinking system, namely the reinforcing inorganic filler and the coupling agent, where appropriate, are intimately incorporated by kneading into the elastomer during the first, “non-productive” phase, that is to say that at least these various base constituents are introduced into the mixer and are thermomechanically kneaded in one or more steps until the maximum temperature of between 130° C. and 200° C., preferably of between 145° C. and 185° C., is reached.

By way of example, the first phase (non-productive phase) is carried out in a single thermomechanical step during which all the necessary constituents, the optional additional processing aids and various other additives, with the exception of the chemical crosslinking agent, are introduced into an appropriate mixer, such as a standard internal mixer. The total duration of kneading in this non-productive phase is preferably between 1 and 15 min. After cooling the mixture thus obtained during the first, non-productive phase, the crosslinking system is then incorporated at low temperature, generally in an external mixer such as an open mill; everything is then mixed (productive phase) for a few minutes, for example between 2 and 15 min.

The final composition thus obtained is subsequently calendered, for example in the form of a sheet or a slab, especially for laboratory characterization, or else extruded in the form of a rubber profiled element employable as semifinished tire product for a vehicle.

Thus, according to a specific embodiment of the invention, the rubber composition according to the invention, which may be either in the uncured state (before crosslinking or vulcanization) or in the cured state (after crosslinking or vulcanization), is a semifinished product that may be used in a tire, especially as a tire tread.

In summary, the invention is advantageously implemented according to any of the following embodiments 1 to 25:

Embodiment 1: Rubber composition that comprises a highly saturated diene elastomer containing 1,3-diene units and more than 50 mol % of ethylene units and bearing at one of its chain ends a functional group of formula —CH₂—CH(CH₃)—COOZ, Z being a hydrocarbon group substituted by a tertiary amine function, a crosslinking system and a reinforcing filler that comprises a silica or a carbon black, the highly saturated diene elastomer being a copolymer of ethylene and a 1,3-diene or a copolymer of ethylene, a 1,3-diene and an α-monoolefin.

Embodiment 2: Rubber composition according to embodiment 1, wherein Z denotes a saturated acyclic hydrocarbon group substituted by a tertiary amine function.

Embodiment 3: Rubber composition according to embodiment 2, wherein the saturated acyclic hydrocarbon group substituted by a tertiary amine function is an alkyl having 1 to 3 carbon atoms.

Embodiment 4: Rubber composition according to any one of embodiments 1 to 3, wherein the tertiary amine function is an N,N-dialkylamino group.

Embodiment 5: Rubber composition according to embodiment 4, wherein the alkyl groups substituting the nitrogen atom each have 1 to 3 carbon atoms.

Embodiment 6: Rubber composition according to embodiment 4 or 5, wherein the alkyl groups substituting the nitrogen atom each have 1 carbon atom or 2 carbon atoms.

Embodiment 7: Rubber composition according to any one of embodiments 1 6, wherein Z denotes an N,N-di(C₁-C₃)alkylamino(C₁-C₃)alkyl group.

Embodiment 8: Rubber composition according to any one of embodiments 1 to 7, wherein Z denotes 2-(N,N-dimethylamino)ethyl, 2-(N,N-diethylamino)ethyl or 2-(N,N-diisopropylamino)ethyl, more preferably 2-(N,N-dimethylamino)ethyl.

Embodiment 9: Rubber composition according to any one of embodiments 1 to 8, wherein the copolymer is a copolymer of ethylene and a 1,3-diene.

Embodiment 10: Rubber composition according to any one of embodiments 1 to 9, wherein the ethylene units in the highly saturated diene elastomer represent at least 60 mol % of all of the monomer units in the highly saturated diene elastomer.

Embodiment 11: Rubber composition according to any one of embodiments 1 to 10, wherein the ethylene units in the highly saturated diene elastomer represent at least 65 mol % of all of the monomer units in the highly saturated diene elastomer.

Embodiment 12: Rubber composition according to any one of embodiments 1 to 11, wherein the ethylene units in the highly saturated diene elastomer represent at least 70 mol % of all of the monomer units in the highly saturated diene elastomer.

Embodiment 13: Rubber composition according to any one of embodiments 1 to 12, wherein the ethylene units in the highly saturated diene elastomer represent less than 90 mol % of all of the monomer units in the highly saturated diene elastomer.

Embodiment 14: Rubber composition according to any one of embodiments 1 to 13, wherein the ethylene units in the highly saturated diene elastomer represent at most 85 mol % of all of the monomer units in the highly saturated diene elastomer.

Embodiment 15: Rubber composition according to any one of embodiments 1 to 14, wherein the ethylene units in the highly saturated diene elastomer represent at most 80 mol % of all of the monomer units in the highly saturated diene elastomer.

Embodiment 16: Rubber composition according to any one of embodiments 1 to 15, wherein the 1,3-diene is 1,3-butadiene, isoprene, myrcene, β-farnesene or mixtures thereof.

Embodiment 17: Rubber composition according to any one of embodiments 1 to 16, wherein the 1,3-diene is 1,3-butadiene or a mixture of 1,3-butadiene and myrcene or else a mixture of 1,3-butadiene and β-farnesene.

Embodiment 18: Rubber composition according to any one of embodiments 1 to 17, wherein the copolymer contains 1,2-cyclohexane units of formula (I).

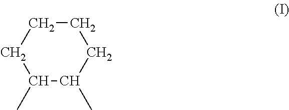

Embodiment 19: Rubber composition according to embodiment 18, wherein the highly saturated diene elastomer contains at most 15 mol % of 1,2-cyclohexane units of formula (I), the percentage being expressed relative to all of the monomer units in the highly saturated diene elastomer.

Embodiment 20: Rubber composition according to any one of embodiments 1 to 19, wherein the α-monoolefin is styrene.

Embodiment 21: Rubber composition according to any one of embodiments 1 to 20, wherein the highly saturated diene elastomer is a statistical copolymer.

Embodiment 22: Rubber composition according to any one of embodiments 1 to 21, wherein the reinforcing filler contains more than 50% by mass of silica.

Embodiment 23: Rubber composition according to any one of embodiments 1 to 22, wherein the crosslinking system is a vulcanization system.

Embodiment 24: Tire that includes a tread, said tire comprising a rubber composition defined in any one of embodiments 1 to 23.

Embodiment 25: Tire according to embodiment 24, said tire comprising said rubber composition in the tread of said tire.

The abovementioned features of the present invention, and also others, will be understood more clearly on reading the following description of examples of implementation of the invention, which are given by way of illustration and without limitation.

### EXAMPLES

### Nuclear Magnetic Resonance (NMR):

The functionalization products of the copolymers are characterized by ¹H, ¹³C and ²⁹Si NMR spectrometry. The NMR spectra are recorded on a Bruker Avance III HD 500 MHz spectrometer equipped with a BBFO Z-grad 5 mm “broad band” cryoprobe. The quantitative ¹H NMR experiment uses a simple 30° pulse sequence and a repetition time of 5 seconds between each acquisition. 64 to 256 accumulations are carried out. The quantitative ¹³C NMR experiment uses a simple 30° pulse sequence with proton decoupling and a repetition time of 10 seconds between each acquisition. 1024 to 10240 accumulations are carried out. ¹H/¹³C two-dimensional experiments are employed for determining the structure of the functional polymers. The axis of the ¹H chemical shifts is calibrated relative to the protonated impurity of the solvent (CDCl₃) at δ_{1H}=7.20 ppm. The axis of the ¹³C chemical shifts is calibrated relative to the signal of the solvent (CDCl₃) at δ_{13C}=77 ppm.

The chemical structure of each functional polymer is identified by NMR (¹H, ¹³C).

### 3D-SEC Analysis:

To determine the number-average molar mass (Mn) and, where appropriate, the weight-average molar mass (Mw) and the polydispersity index (PI, also denoted Ð=Mw/Mn) of the polymers, the method below is used.

The number-average molar mass (Mn), the weight-average molar mass (Mw) and the polydispersity index of the polymer (hereinafter sample) are determined absolutely by triple-detection size-exclusion chromatography (SEC). Triple-detection size-exclusion chromatography has the advantage of measuring average molar masses directly without calibration.

The value for the refractive index increment dn/dc of the solution of the sample is measured on-line using the area of the peak detected by the refractometer (RI) of the liquid chromatography equipment. In order to use this method, it is necessary to check that 100% of the sample mass is injected and eluted through the column. The area of the RI peak depends on the concentration of the sample, on the constant of the RI detector and on the value for dn/dc.

The average molar masses are determined using the 1 g/l solution in tetrahydrofuran previously prepared and filtered, which is injected into the chromatographic line. The apparatus used is a Wyatt chromatographic line. The elution solvent is tetrahydrofuran containing 250 ppm of BHT (2,6-di(tert-butyl)-4-hydroxytoluene), the flow rate is 1 mL·min⁻¹, the temperature of the system is 35° C. and the analysis time is 60 min. The columns used are a set of three Agilent columns of PL Gel Mixed B LS trade name. The volume of sample solution injected is 100 μl. The detection system is made up of a Wyatt differential viscometer of Viscostar II trade name, a Wyatt differential refractometer of Optilab T-Rex trade name of wavelength 658 nm, and a Wyatt multi-angle static light scattering detector of wavelength 658 nm and of Dawn Heleos 8+ trade name. The number-average molar masses and the polydispersity index are calculated by integrating the value for the refractive index increment dn/dc of the sample solution obtained above. The software for processing the chromatographic data is the Astra system from Wyatt.

### Determination of the Glass Transition Temperature of the Polymers:

The glass transition temperature is measured using a differential scanning calorimeter in accordance with the standard ASTM D3418 (1999).

### Dynamic Properties:

The dynamic properties are measured on a viscosity analyser (Metravib VA4000) in accordance with the standard ASTM D 5992-96. The response is recorded of a sample of vulcanized composition (cylindrical test specimen having a thickness of 4 mm and a cross section of 400 mm²), subjected to a simple alternating sinusoidal shear stress, at a frequency of 10 Hz, under standard temperature conditions (23° C.) in accordance with the standard ASTM D 1349-99. A strain amplitude sweep is performed from 0.1% to 50% (outward cycle) and then from 50% to 0.1% (return cycle). The result employed is the loss factor tan (δ). For the return cycle, the observed maximum value for tan (δ), denoted tan (δ) max, is reported. The values for tan (δ) max are given in base 100, the value 100 being assigned to the control composition (T). The lower the value for tan (δ) max, the lower the hysteresis of the rubber composition.

### Preparation of the Elastomers:

The metallocene [{Me₂SiFlu₂Nd(μ-BH₄)₂Li (THF)}]₂ is prepared according to the procedure described in patent application WO 2007/054224.

Butyloctylmagnesium BOMAG (20% in heptane, 0.88 mol·L⁻¹) is obtained from Chemtura and is stored in a Schlenk tube under an inert atmosphere.

Ethylene, of N35 grade, is obtained from Air Liquide and is used without prior purification.

1,3-Butadiene and myrcene are purified on alumina guard tubes.

The functionalization agent used is 2-(dimethylamino)ethyl methacrylate from Sigma-Aldrich. The commercial methacrylate is used after purification on alumina guard tubes and after sparging with nitrogen.

Methylcyclohexane (MCH) solvent obtained from BioSolve is dried and purified on an alumina column in a solvent purifier obtained from mBraun and used under an inert atmosphere.

All reactions are carried out under an inert atmosphere.

### Synthesis of Non-Functional Copolymers of Ethylene, 1,3-Butadiene and Myrcene: Elastomer E1

64 L of MCH and a solution of BOMAG (23 mmol) in MCH (0.01 mol/L) are introduced into a 90 L stainless steel reactor. The reactor is heated to 80° C. and the monomers are added at a controlled rate so as to keep the composition of the monomer mixture constant in the polymerization medium. The ethylene flow rate is set at 40 g/min; the myrcene and the butadiene are injected independently and their flow rates are controlled by the ethylene flow rate in accordance with a myrcene/ethylene weight ratio of 1.62 and in accordance with a butadiene/ethylene weight ratio of 0.25. When the reactor pressure reaches 8 bar, the preformed catalyst system (6.25 mmol Nd) at a concentration of 0.007 mol/L prepared according to the protocol is introduced into the polymerization medium. The chain termination reaction is performed by quenching with methanol when 5 to 6 kg of polymer are formed: the polymer is recovered after a stripping step. The polymer is then dried on a single-screw worm gear machine at 150° C.

The catalyst system is a preformed catalyst system. It is prepared in methylcyclohexane from the metallocene [Me₂Si(C₁₃H₈)₂)Nd(μ-BH₄)₂Li (THF)]₂, the co-catalyst, butyloctylmagnesium (BOMAG) and a preformation monomer, 1,3-butadiene. It is prepared according to a method of preparation in accordance with section II.1 of patent application WO 2017/093654 A1.

5.7 mL of a solution of butyloctylmagnesium in heptane (0.88 M, 5.0 mmol) and 1.462 g of the complex {(Me₂Si(C₁₃H₈)₂)Nd(μ-BH₄)₂Li(THF)}₂ (number of moles of Nd, nNd=2.3 mmol), prepared according to patent application WO 2007/054224 (complex 1), are successively introduced into a 500 mL steinie bottle containing 380 mL of methylcyclohexane degassed beforehand with nitrogen. 17 mL of 1,3-butadiene (hereinafter also denoted butadiene) are added to the steinie bottle at 17° C. The contents of the steinie bottle are then brought to 80° C. for 4 h with stirring. The resulting catalyst solution is stored in a freezer at −25° C.

### Synthesis of Functional Copolymers of Ethylene, 1,3-Butadiene and Myrcene: Elastomer E2

The functional elastomers are prepared under the same synthesis conditions as their non-functional homologues, except that the chain-termination reaction is replaced by a functionalization reaction described according to the functionalization procedure described below.

### Functionalization Procedure:

When the desired monomer conversion has been reached (5 to 6 kg of polymer), the contents of the reactor are degassed and the functionalization agent, the methacrylate, is introduced into the polymerization medium under an inert atmosphere through overpressure in a proportion of 40 equivalents relative to the number of moles of Nd and of Mg introduced into the reactor. The reaction medium is stirred for 15 minutes at 80° C. The reaction medium is deactivated with methanol. The polymer is recovered after a stripping step. The polymer is then dried on a single-screw worm gear machine at 150° C. It is then analysed by SEC (THF) and by ¹H and ¹³C NMR.

The characteristics of the elastomers prepared are shown in Table 1. The SEC and NMR analyses confirm that the chain end of elastomer E2 is functionalized with just one methacrylate monomer unit bearing the amine function.

TABLE 1

| | % | % | % | | | |
|---|---|---|---|---|---|---|
| | ethylene | butadiene | myrcene | % | | |
| | units | units | units | rings (1) | Mn | Tg |
| Elastomer | (mol) | (mol) | (mol) | (mol) | (g/mol) | (° C.) |
| E1 | 74 | 9 | 13 | 4 | 174 000 | −54 |
| E2 | 73 | 10 | 13 | 4 | 180 000 | −54 |

(1) 1,2-cyclohexane ring unit of formula (I)

### Preparation of the Rubber Compositions:

Rubber compositions of the formulation expressed in phr (parts by weight per hundred parts by weight of elastomer) shown in Table 2 were prepared according to the following procedure: the elastomer, the silica, the coupling agent and also the various other ingredients with the exception of the vulcanization system are successively introduced into an 85 cm³ Polylab internal mixer (end filling level: approximately 70% by volume) having an initial vessel temperature of approximately 100° C. Thermomechanical working (non-productive phase) is then carried out in a step lasting a total of approximately 5 min until a maximum dropping temperature of 160° C. is reached. The mixture thus obtained is recovered and cooled and then sulfur and the accelerator are incorporated on a mixer (homo-finisher) at 25° C., the entirety (productive phase) being mixed for approximately ten minutes. The compositions thus obtained are then calendered, either in the form of rubber plates (thickness 2 to 3 mm) or thin rubber sheets, for measurement of their physical or mechanical properties after vulcanization at 150° C.

The rubber composition C1 contains a highly saturated diene elastomer bearing at the chain end a methacrylate monomer unit, elastomer E2. This is in accordance with the invention. The rubber composition T1 contains a highly saturated diene elastomer that has not been functionalized, E1. It is synthesized according to the same procedure as elastomer E2, except that the functionalization agent is not added, the method proceeding directly with the step of precipitation from the reaction medium in methanol after degassing of the reactor.

The results are shown in Table 3.

Rubber composition C1 displays much lower hysteresis than that of its control, composition T1. This reduction in hysteresis is attributed to the functionalization of the chain end of the highly saturated diene elastomer by a single monomer unit of a methacrylate bearing a tertiary amine function, since this result is obtained without the modification of the elastomer by the methacrylate being accompanied by the formation of a polymethacrylate block that would result in a change in the glass transition temperature of the rubber composition and thus in a change in certain properties of the rubber compositions, such as the rheological properties, in particular the stiffness.

TABLE 2

| Compositions (in phr) | T1 | C1 |
|---|---|---|
| Elastomer E1 | 100 | |
| Elastomer E2 | | 100 |
| Silica (1) | 70 | 70 |
| Carbon black (2) | 2 | 2 |
| Coupling agent (3) | 7 | 7 |
| DPG (4) | 1.2 | 1.2 |
| Ozone wax (5) | 2.5 | 2.5 |
| Antioxidant (6) | 3.8 | 3.8 |
| Antioxidant (7) | 1.6 | 1.6 |
| Stearic acid (8) | 3 | 3 |
| ZnO (9) | 0.9 | 0.9 |
| Sulfur | 0.9 | 0.9 |
| CBS (10) | 2.3 | 2.3 |

(1) Zeosil 1165 MP from Solvay-Rhodia in the form of microbeads
(2) N234
(3) Liquid silane (TESPT) Si69 from Evonik
(4) Diphenylguanidine, Perkacit DPG from Flexsys
(5) Anti-ozone wax, Varazon 4959 from Sasol Wax
(6) N-(1,3-Dimethylbutyl)-N′-phenyl-p-phenylenediamine, Santoflex 6PPD from Flexsys
(7) Tetramethylquinone
(8) Stearic acid, Pristerene 4931 from Uniqema

What is claimed is:

1. A rubber composition, comprising:
a saturated diene elastomer containing 1,3-diene units and more than 50 mol % of ethylene units, and the saturated diene elastomer bearing at one of its chain ends a functional group of formula —CH₂—CH(CH₃)—COOZ, Z being a hydrocarbon group substituted by a tertiary amine function,
a crosslinking system, and
a reinforcing filler that comprises a silica or a carbon black,
the saturated diene elastomer being a copolymer of ethylene and a 1,3-diene or a copolymer of ethylene, a 1,3-diene and an α-monoolefin.

2. The rubber composition according to claim 1, wherein Z denotes a saturated acyclic hydrocarbon group substituted by a tertiary amine function.

3. The rubber composition according to claim 2, wherein the saturated acyclic hydrocarbon group substituted by a tertiary amine function is an alkyl having 1 to 3 carbon atoms.

4. The rubber composition according to claim 1, wherein the tertiary amine function is an N,N-dialkylamino group.

5. The rubber composition according to claim 4, wherein the alkyl groups substituting the nitrogen atom each have 1 to 3 carbon atoms.

6. The rubber composition according to claim 1, wherein Z denotes an N,N-di(C₁-C₃)alkylamino(C₁-C₃)alkyl group.

7. The rubber composition according to claim 1, wherein the copolymer is a copolymer of ethylene and a 1,3-diene.

8. The rubber composition according to claim 1, wherein the ethylene units in the saturated diene elastomer represent less than 90 mol % of all of the monomer units in the saturated diene elastomer.

9. The rubber composition according to claim 1, wherein the 1,3-diene is 1,3-butadiene, isoprene, myrcene, β-farnesene or mixtures thereof.

10. The rubber composition according to claim 1, wherein the 1,3-diene is 1,3-butadiene, a mixture of 1,3-butadiene and myrcene, or a mixture of 1,3-butadiene and β-farnesene.

11. The rubber composition according to claim 1, wherein the copolymer contains 1,2-cyclohexane units of formula (I):

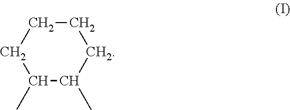

12. The rubber composition according to claim 1, wherein the saturated diene elastomer is a statistical copolymer.

13. The rubber composition according to claim 1, wherein the reinforcing filler contains more than 50% by mass of silica.

14. A tire comprising a tread, said tire comprising the rubber composition as defined in claim 1.

15. The rubber composition according to claim 5, wherein the alkyl groups substituting the nitrogen atom each have 1 to 2 carbon atoms.

16. The rubber composition according to claim 6, wherein Z denotes 2-(N,N-dimethylamino)ethyl, 2-(N,N-diethylamino)ethyl or 2-(N,N-diisopropylamino)ethyl.

17. The rubber composition of claim 16, wherein Z denotes 2-(N,N-dimethylamino)ethyl.

18. The tire of claim 14, wherein the rubber composition is present in the tread of the tire.
